(19) United States
(12) Patent Application Publication
(10) Pub. No.: US 2011/0012986 A1
(43) Pub. Date: Jan. 20, 2011

(54) PRINTING APPARATUS AND PRINTING METHOD USING THE SAME

(76) Inventors: Shinichi Shikll, Nara (JP); Kiminori Mizuuchi, Ehime (JP); Shinichi Kadowaki, Hyogo (JP); Hiroyuki Furuya, osaka (JP); Kazuhisa Yamamoto, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/920,226

(22) PCT Filed: Mar. 23, 2009
(86) PCT No.: PCT/JP2009/001269

§ 371 Date: Aug. 30, 2010

(30) Foreign Application Priority Data
Mar. 27, 2008 (JP) 2008 082789

(51) Int. Cl. B41J 15/14

(52) U.S. Cl. 347/241

(57) ABSTRACT

Provided is a printing apparatus for printing information on a printing area of an object to be printed by irradiating the object to be printed with a first laser beam. The printing apparatus includes a light source for outputting the first laser beam, a light collecting optical system for collecting the first laser beam to the printing area of the object to be printed, and a scanning unit for performing scanning with the first laser beam. The object to be printed contains moisture at least in the printing area, and a wavelength of the first laser beam is 350 nm or more and 550 nm or less.

### TECHNICAL FIELD

The present invention relates to a printing apparatus for directly marking information such as the freshness date or indication of origin on an object to be printed such as perishable food by using a laser beam, and to a printing method using such a printing apparatus.

### BACKGROUND ART

Based on the increasing health trend in recent years, general consumers are developing a strong tendency to care about the freshness and origin of perishable food and the like. Thus, there are demands for clarifying the freshness and the like by adding information such as the date of packing, freshness date, origin or manufacturer on the perishable food.

Conventionally, in order to add the foregoing information, prescribed information was printed on the package of the perishable food or a label indicating such prescribed information was attached to the package of the perishable food. Nevertheless, extra costs are required if packages or labels are used. Moreover, since the ink used for printing and the adhesive used for attaching labels are not food, there was problem in that such ink or adhesive would sometimes adhere to the perishable food and the like.

Thus, as a method that does not use packages, labels, ink or adhesive, proposed is a method of irradiating a laser beam directly on the perishable food to perform printing on the surface of the perishable food (for example, refer to Patent Document 1). For instance, a CO₂ laser beam with a wavelength of approximately 10 μm is used to scan the perishable food using a polygon mirror and directly mark the surface of the perishable food.

In addition, there is another example of marking a symbol, picture or figure on the surface of a soft capsule which is internally filled with edibles with a Nd:YAG laser with a wavelength of 1.06 μm in order to specify the contents and indicate the history such as the date of packing (for example, refer to Patent Document 2).

Moreover, there is another example of printing prescribed information by forming a marking layer made of an edible while constantly focusing the laser beam of a YAG laser or the like on the surface of confectionaries such as chocolates which have an uneven surface (for example, refer to Patent Document 3). According to these methods, packages or labels for printing are no longer required, and there is no health concern since the printed marking layer is made of an edible.

Nevertheless, with the conventional technologies described above, since a laser beam is focused and irradiated onto a part of the surface of the object to be printed containing moisture such as perishable food, the object to be printed would often suffer considerable damage. As the cause of such damage, one reason is that the laser beam is absorbed by the moisture contained in the object to be printed such as perishable food, thereby causing vapor explosion. Consequently, a part of the object to be printed becomes damaged and there is a problem in that the appearance is impaired. In particular, with perishable food, the protein deteriorates as the temperature rises. If bacterial propagates at the deteriorated portion, the protein begins to decompose around the deteriorated portion, and decomposition will advance. Thus, there is a problem in that the commodity value itself would decrease due to the deterioration of freshness and shortening of the storage period.

### Patent Document 1: Japanese Patent Application Laid-open No. 2000-168157

### Patent Document 2: Japanese Patent Application Laid-open No. 2004-8012

### Patent Document 3: Japanese Patent Application Laid-open No. 2005-138140

### DISCLOSURE OF THE INVENTION

Thus, an object of the present invention is to provide a printing apparatus capable of inhibiting the rise in temperature of the printing area of the object to be printed caused by the laser beam being absorbed by the moisture contained in the object to be printed, and performing a clear marking with high resolution only on the surface of the object to be printed.

In order to achieve the foregoing object, the printing apparatus according to one aspect of the present invention is a printing apparatus for printing information on a printing area of an object to be printed by irradiating the object to be printed with a first laser beam, including a light source for outputting the first laser beam, a light collecting optical system for collecting the first laser beam to the printing area of the object to be printed, and a scanning unit for performing scanning with the first laser beam, wherein the object to be printed contains moisture at least in the printing area, and wherein a wavelength of the first laser beam is 350 nm or more and 550 nm or less.

According to the foregoing configuration, it is possible to reduce the ratio in which the laser beam is absorbed by the moisture, and inhibit the generation of heat caused by the absorption of the laser beam. Accordingly, high resolution marking can be performed without damaging the object to be printed containing moisture.

The object, features and superior aspects of the present invention should be sufficiently understood based on the following descriptions. Moreover, the advantages of the present invention will become clearer based on the ensuing detailed explanation and attached drawings.

### BRIEF DESCRIPTION OF THE DRAWINGS

FIG. 1 is an explanatory diagram showing a schematic configuration of the printing apparatus according to an embodiment of the present invention.

FIG. 2A is an explanatory diagram showing a schematic configuration of the printing apparatus according to an embodiment of the present invention, and FIG. 2B is an explanatory diagram showing a schematic configuration of the light collecting optical system in the printing apparatus of FIG. 2A.

FIG. 3 is an enlarged view of the printing area of the object to be printed to which printing was performed with the printing apparatus according to an embodiment of the present invention.

FIG. 4 is an explanatory diagram showing the changes in the absorption coefficient of water in relation to the wavelength of light.

FIG. 5 is an explanatory diagram explaining the expansion of the beam in the vicinity of the waist position in the laser beam.

FIG. 6A is an explanatory diagram showing a schematic configuration of the printing apparatus according to an embodiment of the present invention, and FIG. 6B is an explanatory diagram showing a situation where a laser beam is entering a water tank of the printing apparatus of FIG. 6A.

FIG. 7A is a perspective view showing a schematic configuration of the water tank of the printing apparatus according to another embodiment of the present invention, and FIG. 7B is a plan view showing a schematic configuration of the water tank of FIG. 7A.

FIG. 8 is a plan view showing the relevant part of the printing apparatus according to another embodiment of the present invention.

FIG. 9 is a schematic diagram showing the printing of an interference pattern according to an embodiment of the present invention.

FIG. 10A is a perspective view showing the relevant part of the printing apparatus according to another embodiment of the present invention, and FIG. 10B is a perspective view showing the relevant part of the printing apparatus according to another embodiment of the present invention.

FIG. 11 is an explanatory diagram showing a schematic configuration of the printing apparatus according to another embodiment of the present invention.

FIG. 12 is an explanatory diagram showing a configuration of separating the infrared laser beam and the visible laser beam and irradiating them on an object to be printed according to another embodiment of the present invention.

FIG. 13A is a waveform diagram showing the strength waveform of a fundamental wave entering the wavelength conversion element in the laser beam source according to another embodiment of the present invention, FIG. 13B is a waveform diagram showing the strength waveform of a second harmonic wave when the fundamental wave of FIG. 13A is converted into the second harmonic wave with the wavelength conversion element, and FIG. 13C is a waveform diagram showing the strength waveform of a fundamental wave when the fundamental wave of FIG. 13A is not converted into a second harmonic wave with the wavelength conversion element and is transmitted through the wavelength conversion element.

FIG. 14 is an explanatory diagram showing a schematic configuration of the printing apparatus according to another embodiment of the present invention.

FIG. 15 is a conceptual diagram of separating the same laser beam of the printing apparatus according to yet another embodiment of the present invention.

FIG. 16 is an explanatory diagram showing a schematic configuration of the printing apparatus according to yet another embodiment of the present invention.

FIG. 17 is an explanatory diagram showing a configuration of separating the infrared laser beam, the visible laser beam and the ultraviolet laser beam and irradiating them on an object to be printed according to yet another embodiment of the present invention.

FIG. 18 is an explanatory diagram showing the relation of the beam shape on the surface of the object to be printed in the printing apparatus according to yet another embodiment of the present invention.

### BEST MODE FOR CARRYING OUT THE INVENTION

### First Embodiment

The printing apparatus according to an embodiment of the present invention is now explained with reference to the attached drawings. Incidentally, configurations that are given the same reference numeral in the respective drawings mean that they are of the same configuration, and the explanation thereof is omitted.

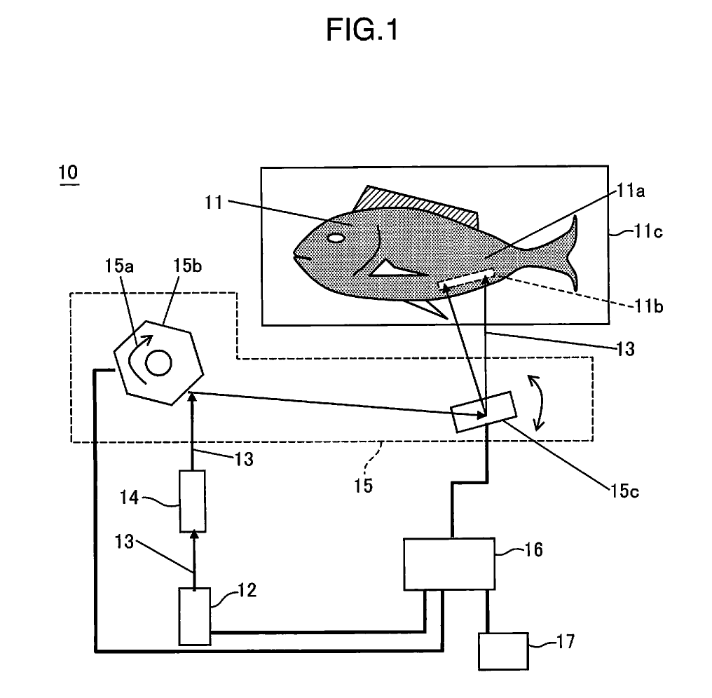

FIG. 1 shows a schematic configuration of a printing apparatus 10 according to an embodiment of the present invention.

The printing apparatus 10 of the present embodiment irradiates a laser beam onto an object to be printed 11 containing moisture on its surface (printing surface) in order to print information on the surface of the object to be printed 11. The printing apparatus 10 comprises a laser beam source 12 for outputting a laser beam 13 with a wavelength of 350 nm or more and 550 nm or less, a light collecting optical system 14 for collecting the laser beam 13 output from the laser beam source 12 to a surface 11a of the object to be printed 11, and a scanning unit 15 for performing scanning with the laser beam 13 on the surface of the object to be printed 11. Here, as the object to be printed 11, FIG. 1 shows seafood such as fish as an example.

The scheme of the operation of the printing apparatus 10 is now explained. The laser beam 13 output from the laser beam source 12 foremost enters the light collecting optical system 14. The light collecting optical system 14 includes a condensing lens or the like for accurately collecting the laser beam 13 on the surface of the object to be printed 11. The laser beam 13 that passed through the light collecting optical system 14 subsequently enters the scanning unit 15. Here, the scanning unit 15 includes a polygon mirror 15b for causing the laser beam 13 to perform scanning in the horizontal direction by rotating in the direction of an arrow 15a, and a movable reflecting mirror 15c for moving the laser beam 13 in a direction that is vertical to the scanning direction. The laser beam 13 that entered the scanning unit 15 is caused to perform one-dimensional scanning by the polygon mirror 15b, and is subsequently caused to perform scanning in a direction that is perpendicular to the scanning direction of the polygon mirror 15b by the movable reflecting mirror 15c, and is thereby caused to perform two-dimensional scanning on the object to be printed 11.

The laser beam source 12 and the scanning unit 15 are electrically and mechanically controlled with a control unit 16. When the control unit 16 decides the information such as text to be printed, the control unit 16 synchs with the operation of the scanning unit 15 and controls the modulation of the laser beam 13 according to the information to be indicated on the object to be printed 11. Intended information is thereby printed on the object to be printed 11.

Moreover, the printing apparatus 10 of the present embodiment is equipped with a GPS (Global Positioning System) sensor 17. As shown in FIG. 1, by connecting the GPS sensor 17 to the control unit 16 and including the position information obtained with the GPS sensor 17 in the contents to be printed on the object to be printed 11 under the control by the control unit 16, the harvesting location or landing location can be directly recorded on the object to be printed 11. Consequently, this will lead to the prevention of fish poaching or mislabeling, improve the brand value of the object to be printed which was printed with the printing apparatus 10, and bring a sense of safety to the buyers.

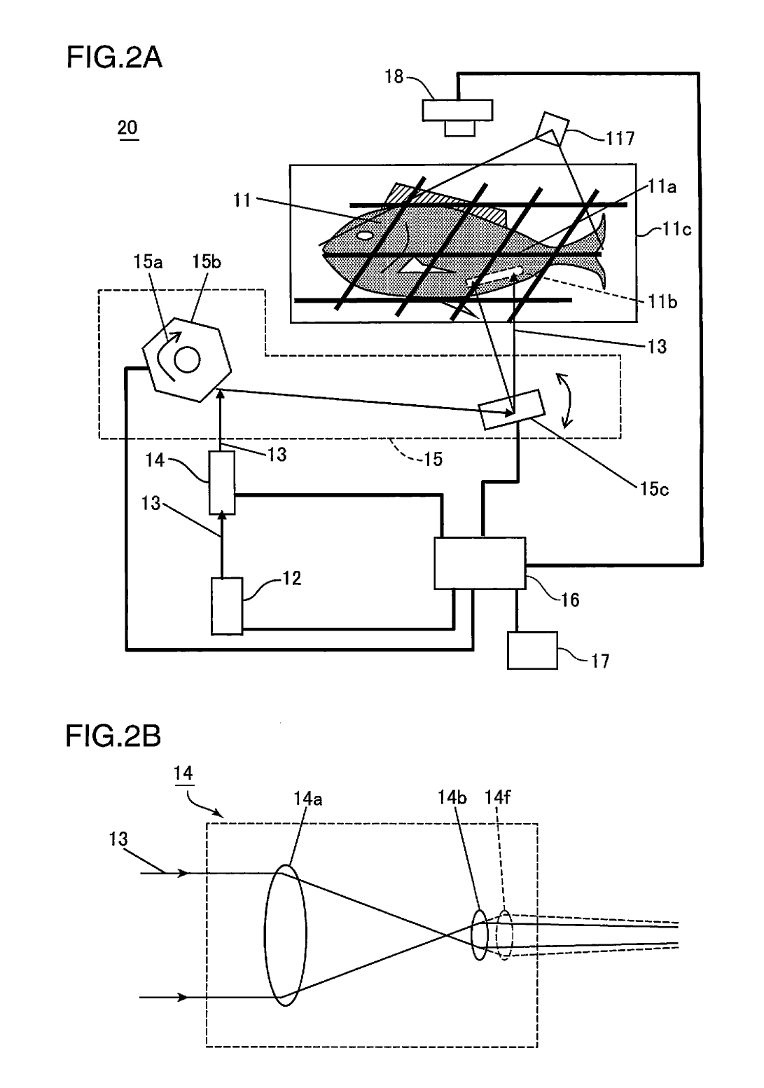

Here, as with the printing apparatus shown in FIG. 2A, by also connecting the light collecting optical system 14 to the control unit 16 and adjusting, in real time, the position of the lens or the like contained in the light collecting optical system 14 so that the focal point of the laser beam 13 will be on the surface of the object to be printed 11 under the control by the control unit 16, higher resolution printing is enabled. For example, in FIG. 2A, by irradiating a prescribed pattern (lattice pattern in this example) from a projection device 117 to the object to be printed 11, capturing the image with a camera 18 and processing the image with the control unit 16, it is possible to decide at which scanning position and at which height the laser beam 13 should be collected. By adjusting the position of the lens 14b among a plurality of lenses 14a, 14b configuring the light collecting optical system 14 to an optical axis direction in accordance with the obtained optimal light collecting position information as shown, for example, in FIG. 2B, the light collecting position in the optical axis direction on the object to be scanned 11 can be adjusted in real time. For example, in the case of FIG. 2B, by moving the lens 14b to a rear position 14f on the optical axis, the light collecting position can be moved further forward. Consequently, the light collecting position can be constantly set to be on the surface 11a of the object to be printed 11 regardless of the shape of the object to be printed 11. Note that the method shown in FIG. 2A and FIG. 2B is an example of adjusting the focusing position of the laser beam 13 according to the shape of the object to be printed 11, and other methods may also be used for achieving the same result. For example, the pattern to be irradiated on the surface of the object to be printed 11 may be a result of performing scanning with linear light, or the shape of the object to be printed may be obtained by capturing the object to be printed 11 with a stereo camera and processing the obtained image.

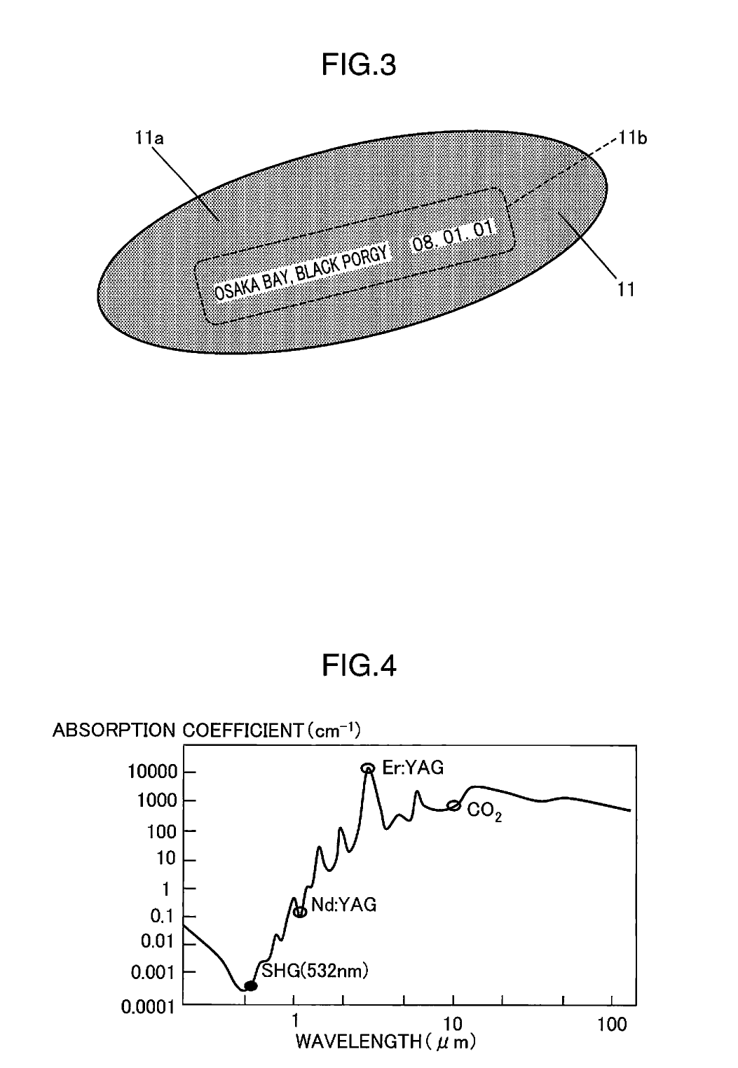

FIG. 3 shows an enlarged view in the vicinity of the surface 11a of the object to be printed 11 to which information was printed with the printing apparatus 10. As shown in FIG. 3, the origin, type of fish, and date that the fish was caught are printed as an example shown as “Osaka Bay, Black Porgy, 08.01.01” are printed at a prescribed printing area 11b on the surface 11a of the object to be printed 11 containing moisture. Specifically, this shows that the fish was a black sea bream caught in Osaka Bay on Jan. 1, 2008. Note that the object to be printed 11 is mounted and retained on a mounting table 11c shown in FIG. 1 and FIG. 2A.

The effect of using a wavelength band in the range of 350 nm or more and 550 nm or less with respect to the wavelength of the laser beam 13 in the present embodiment is now explained with reference to FIG. 4. FIG. 4 shows the changes in the absorption coefficient of water in relation to the wavelength of light. As the laser beam of the printing apparatus of the conventional technology, a Nd:YAG laser (absorption coefficient 0.1 cm⁻¹), Er:YAG laser (absorption coefficient 10000 cm⁻¹) or CO₂ laser (absorption coefficient 500 cm⁻¹), all with a wavelength of 1 μm or more, is being used. If this kind of conventional laser beam is used, since the absorption coefficient of being absorbed by water is great, the moisture contained in the object to be printed will be heated excessively when printing is performed with the printing apparatus, and vapor explosion will thereby occur. The vapor explosion caused by the moisture contained in the object to be printed may damage the printing surface of the object to be printed. If the cells of the object to be printed are damaged, the bacteria in the air will propagate around the damaged portion, and the freshness of the cells will rapidly deteriorate.

With the printing apparatus 10, 20 according to the first embodiment shown in FIG. 1 and FIG. 2A, a visible laser beam 13 with a wavelength of 350 nm or more and 550 nm or less is used for printing on the printing object 11. This wavelength band belongs to an area where the adsorption coefficient of water is the lowest at 0.001 cm⁻¹ or less as shown in FIG. 4. The absorption coefficient of the wavelength band is a value that is lower by 2 digits or more in comparison to the conventional Nd:YAG laser, and 6 digits or more in comparison to the Er:YAG laser and the CO₂ laser. Since the printing apparatus 10, 20 of the present embodiment uses a laser beam 13 of a wavelength band in which the absorption coefficient of water is 0.001 cm⁻¹ or less, it is possible to prevent the internal moisture in the vicinity of the surface 11a of the object to be printed 11 from becoming heated excessively, and subsequently causing vapor explosion. As described above, the printing apparatus 10, 20 of the present embodiment is able to reduce the absorption of the laser beam 13 by the moisture, it is possible to inhibit the generation of heat caused by the absorption of the laser beam 13 by the moisture contained in the object to be printed 11. Thus, high resolution marking can be performed without damaging the object to be printed 11 containing moisture. In addition, since absorption by the moisture is small, printing can be performed with smaller power than conventionally, and it is thereby possible to reduce the power required for printing.

Although the scanning unit 15 is configured by including a polygon mirror 15b and a movable reflecting mirror 15c in the present embodiment, other configurations may be adopted so long as the laser beam 13 can be caused to perform two-dimensional scanning relative to the object to be printed 11. For example, a two-dimensional MEMS mirror or the like may be used, or the object to be printed 11 can be placed on a stage not shown and the state can be moved two-dimensionally without causing the laser beam 13 to perform scanning.

Incidentally, FIG. 1 and FIG. 2A illustrate the underpart of the fish as the printing area 11b of the object to be printed 11, but it may also be other parts. In particular, if printing is performed on the fin part such as the tail fin of the fish, damage to the fish is further alleviated, and this is effective for preventing the deterioration in the survival rate of the fish after marking in cases of marking the fish that was captured for biological research or the like and subsequently releasing the fish.

The laser beam source 12 is now explained. The wavelength of the laser beam source 12 is 350 nm or more and 550 nm or less, and, as a mode of being able to obtain high output in this wavelength range, considered may be a wavelength conversion laser beam that is obtained by converting wavelength of the infrared laser beam. In the foregoing case, a nonlinear optical element (wavelength conversion element) configured from a periodic polarization inverted structure is preferably used. As the crystal of the wavelength conversion element, MgO:LiNbO₃, Mg:LiTaO₃, and KTP can be used, and as such crystal structure there is a congruent composition, stoichiometric composition, quartz crystal, fluoride crystal, and the like. For example, by entering a YAG laser or the like with a wavelength of 1064 nm as the fundamental wave in the foregoing wavelength conversion elements, a green laser with a wavelength of 532 nm can be obtained as the second harmonic wave. In the foregoing case, as the fundamental wave to enter the wavelength conversion element, desirably, a fundamental wave that was output from a single mode fiber laser is used. For example, by entering excitation light with a wavelength of 915 nm or 975 nm in a double clad fiber laser in which a rare earth element Yb or the like is doped to the core portion and a resonator is formed at both ends with fiber grating, it is possible to obtain a fundamental wave with a watt-level high output while the transverse mode is essentially a single mode. The second harmonic wave that is obtained by entering this fundamental wave into the wavelength conversion element will also have a transverse mode that is a single mode. For example, by setting the fiber grating so that an infrared light with a wavelength of 1064 nm is obtained as the fundamental wave, a high quality beam of 532 nm and in which its transverse mode is a single mode can be obtained as the second harmonic wave.

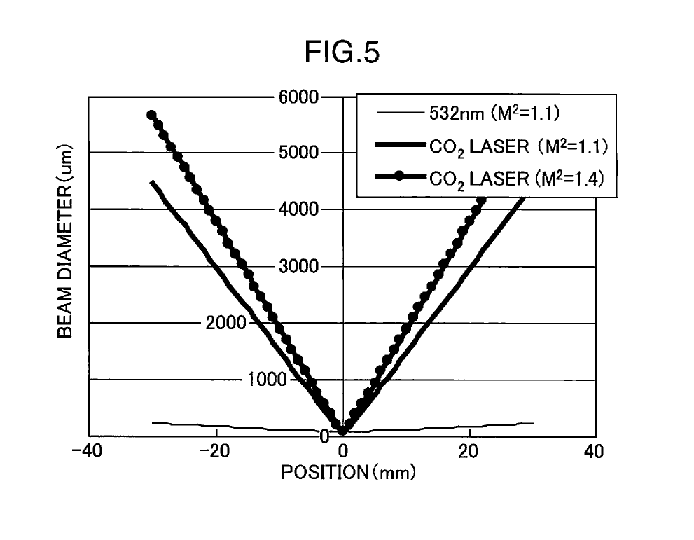

Generally speaking, if the laser beam is to be collected to a certain beam diameter, the laser beam has a property of spreading as it withdraws from the beam waist position. The spread angle thereof is smaller as the wavelength is shorter, and smaller as the beam quality is more favorable. The beam quality is quantified with a value of M², and M² of the laser beam in which the transverse mode is a single mode is approximately 1, and the M² value increases as the mode increases and the beam quality deteriorates. With the second harmonic wave obtained by converting wavelength of the fundamental wave that was output from the foregoing fiber laser in which the transverse mode is a single mode, the M² value is approximately 1 since the transverse mode is a single mode, but the M² value is normally around 1.4 with a CO₂ laser or the like that was conventionally used for processing, and the transverse mode is not a single mode. As an example, FIG. 5 shows a state where the respective laser beams were collected until the respective beam waist diameters (diameter, 1/e²) reached 100 μm and the laser beam is spreading in the vicinity of the beam waist with respect to the laser beam with a wavelength of 532 nm and M²=1.1, CO₂ laser beam (wavelength 10.6 μm) of M²=1.1, and CO₂ laser beam of M²=1.4. Even if it is the same M² value, the spread of the wavelength of 532 nm is considerably smaller between the wavelength of 532 nm and the wavelength of 10.6 μm. In addition, even if it is the same wavelength, it is obvious that the spread angle of the laser beam of M²=1.1 is smaller than the laser beam of M²=1.4. Thus, even if there is slight unevenness on the printing area 11b of the object to be printed 11, it is possible to perform printing with a much higher resolution by using a laser beam with a wavelength of 532 nm and in which the transverse mode is a single mode in comparison to using the respective CO₂, laser beams.

Moreover, when using the second harmonic wave (wavelength 350 nm or more and 550 nm or less) obtained by converting wavelength of the fundamental wave that was output from a fiber laser in which the transverse mode is a single mode, if the conditions where the unevenness of the printing area 11b of the object to be printed 11 is ±20 mm or less and the beam diameter of the laser beam for printing is 200 um or less can be tolerated, the mechanism for adjusting the position of the lens 14b of the light collecting optical system 14 according to the state of focus is no longer required, and the printing apparatus 10 can be configured extremely simply and at low cost. Meanwhile, with the CO₂ laser beam of M²=1.1, an unevenness of ±2 mm will immediately result in the beam diameter exceeding 200 μm, and with the CO₂ laser beam of M²=1.4, an unevenness of ±1 mm will result in the beam diameter exceeding 200 μm, and high resolution printing cannot be performed on the object to be printed with an unevenness unless the focusing position is adjusted.

Although the object to be printed 11 contains moisture in the present embodiment, the effect of reducing the spread angle as described above is effective regardless of whether or not the object to be printed contains moisture, and the same effect can be yielded regardless of the object to be printed.

Here, the laser beam 13 may be a CW (Continuous Wave), but it will yield the effect of being able to perform high resolution printing if it is a pulsed light. Based on the irradiation for an extremely short period of time with the pulsed light, it is possible to inhibit the generation of heat at the position where the laser beam 13 is irradiated, and the printing spot size can be minimized.

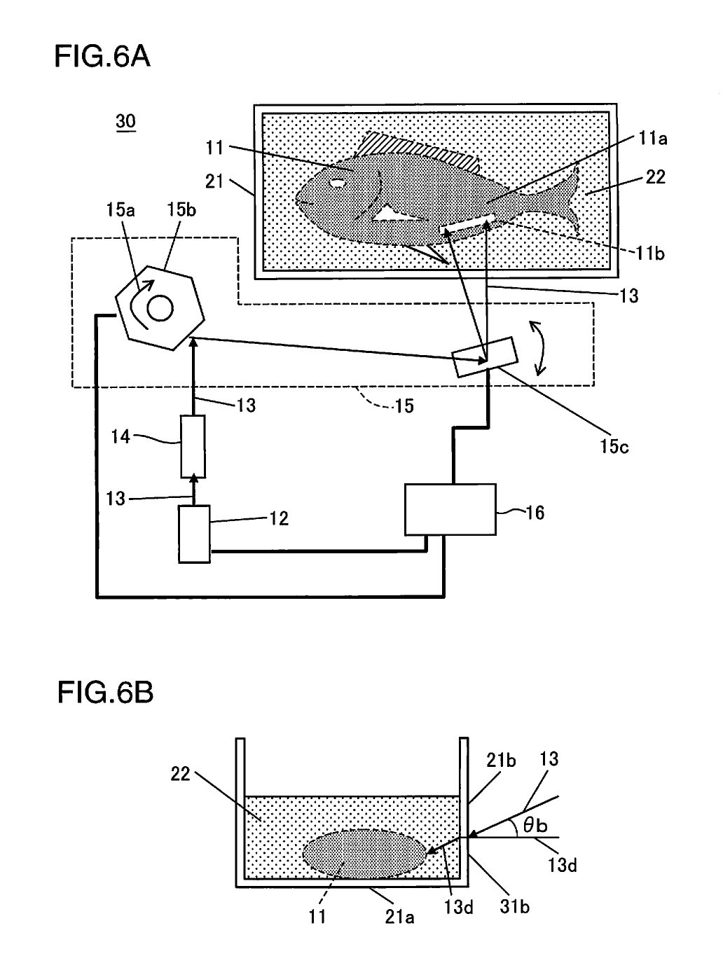

FIG. 6A and FIG. 6B show a schematic configuration of another printing apparatus 30 according to the first embodiment of the present invention. The printing apparatus 30 shown in FIG. 6A is basically configured the same as the printing apparatus 10, 20 shown in FIG. 1 and FIG. 2A, but differs in that the object to be printed 11 is placed in water 22 filled in a water tank 21 in substitute for the mounting table 11c. Specifically, the printing apparatus 30 additionally comprises a water tank 21 for placing the object to be printed 11 in the water 22, and the laser beam 13 is irradiated onto the object to be printed 11 via the water 22. Even with this kind of configuration, if the wavelength of the laser beam 13 is 350 nm or more and 550 nm or less, since it is hardly absorbed by the water 22, most of the laser beam 13 that enters the water tank 21 will reach the object to be printed 11. Thus, it is possible to configure a printing apparatus with low energy loss and low power consumption. As shown in FIG. 4, the absorption coefficient of the water 22 is 0.001 cm⁻¹ if the wavelength is 532 nm, and this 1 cm⁻¹ with a YAG laser (wavelength of 1064 nm), and becomes 1000 cm⁻¹ with a CO₂ laser (10.6 μm). Thus, even if the laser beam has the same light quantity, a laser beam with a wavelength of 532 nm is able to permeate 1000 cm in the water, whereas a YAG laser is only able to permeate 1 cm, and a CO₂ laser is only able to permeate approximately 0.001 cm.

Moreover, when removing the fish kept in the water for printing, droplets are adhered to the surface. Thus, if the laser beam for printing enter into the droplets, the droplets work like a lens and, also due to the aberration of the droplets, it may become difficult to collect the beam on the surface of the object to be printed. Meanwhile, if the object to be printed is placed in the water 22 filled in the water tank 21 as with the printing apparatus 30 of the present embodiment, since the laser beam to be used for the printing has a wavelength of 350 nm or more and 550 nm or less, there is an advantage in that the light collecting characteristics of the laser beam will not deteriorate due to the droplets, and high resolution printing is enabled thereby.

In addition, as described above, if the laser beam 13 is pulsed light, printing with even higher resolution is possible, but as a result of performing printing to the object to be printed 11 in the water as in the present case, the cooling with the water 22 is promoted, and there is an advantage in that printing with even higher resolution is possible. For example, a barcode or the like can be printed inconspicuously on an extremely small area of the object to be printed 11.

With this kind of printing apparatus 30, it is possible to instantaneously record the origin and date of capture on the fish, shellfish such as crabs and shrimp, clams and other living objects to be printed 11 that are slowly swimming in the water tank 21 without requiring the rise in temperature. The operation of the constituent elements other than the water tank 21 of the printing apparatus 20 is the same as the printing apparatus 10 according to the first embodiment, and the explanation thereof is omitted.

Moreover, as shown in FIG. 6B, the laser beam 13 enters the water tank 21 either from the bottom face 21a or the side faces 21b of the water tank 21, and, for example, enters at a Brewster's angle θb relative to the normal line 13d of the side face 21b. If the laser beam 13 is single polarization and is entering the side face 21b at P polarization, the reflection on the side face 21b can be eliminated by entering the laser beam 13 into the side face 21b at an angle in the vicinity of the Brewster's angle θb. Meanwhile, a CO₂ laser for printing is sometimes output at random polarization, and in this case the S polarization component will always be reflected at the entrance plane of the water tank, and the reflected light at the entrance plane cannot be inhibited even if it enters the surface of the water tank at a Brewster's angle. Meanwhile, since the harmonic obtained with the wavelength conversion is single polarization, the reflection at the entrance plane of the water tank 21 can be inhibited by entering the surface of the water tank 21 at a Brewster's angle θb with P polarization. Note that if the laser beam 13 enters the surface of the water tank 21 at an angle other than in the vicinity of the Brewster's angle θb, for example, if it perpendicularly enters the side face 31b, a reflected light of 4% will arise from the water tank surface, and a special mechanism or the like may be required for ensuring the safety of the person operating the printing apparatus 30. Nevertheless, by entering the laser beam 13 into the surface of the water tank 21 at an angle that is in the vicinity of the Brewster's angle θb as described above, it is possible to configure a printing apparatus 30 that is safe for the eyes, with minimal loss, and of high efficiency. If the refractive index of the water tank 21 is set to 1.5 and the refractive index of the water 22 is set to 1.33, the Brewster's angle θb entering the water tank 21 from the air will correspond to 56°, and the laser beam 13 that entered the water tank 21 from the air at this Brewster's angle θb will enter the water in the water tank 21 at an angle of 33°. Here, the P polarization reflectance at the boundary of the water tank 21 and the water is an extremely low reflectance of 0.1% or less.

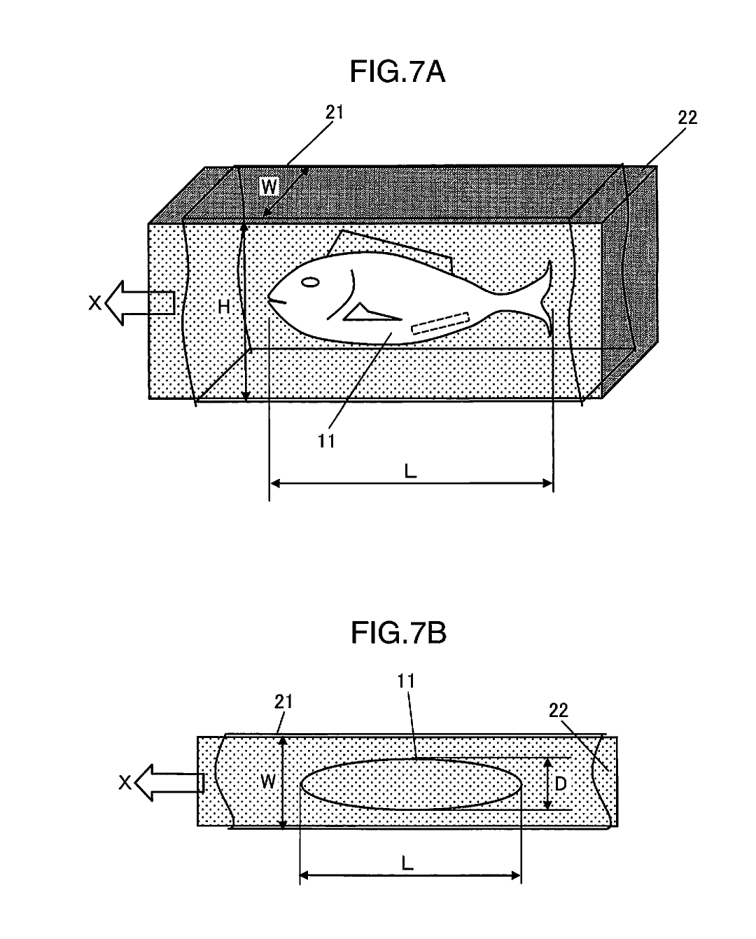

The method of improving the printing throughput is now explained with reference to FIG. 7A and FIG. 7B. FIG. 7A is a perspective view of the water tank 21, and FIG. 7B is a plan view of the water tank 21 of FIG. 7A. In FIG. 7, the water 22 in the water tank 21 is forced to flow in a unilateral direction (X direction in the drawings), and the object to be printed 11 (fish in the drawings) is caused to flow in that direction. Here, in order to prevent the fish from swimming in a direction that is opposite to the X direction, the width W and height H in the cross section that is perpendicular to the X direction (water flow direction) of the water tank are made to be shorter than the length L of the fish in the X direction. Consequently, the fish will flow in the X direction without swimming in the opposite direction. Thus, by placing fish after fish in the water tank 21 in the foregoing state and performing printing to the fish flowing in the water 22, printing can be performed continuously to the fish, and the printing throughput can be dramatically improved. Moreover, by setting the width W of the water tank 21 to be twice or less of the width D of the object to be printed 11, it is possible to prevent two objects to be printed 11 from flowing simultaneously. Thus, printing omissions can be prevented. Similarly, by setting the height H of the water tank 21 to be twice or less of the height of the object to be printed 11, it is possible to prevent two objects to be printed 11 from flowing simultaneously.

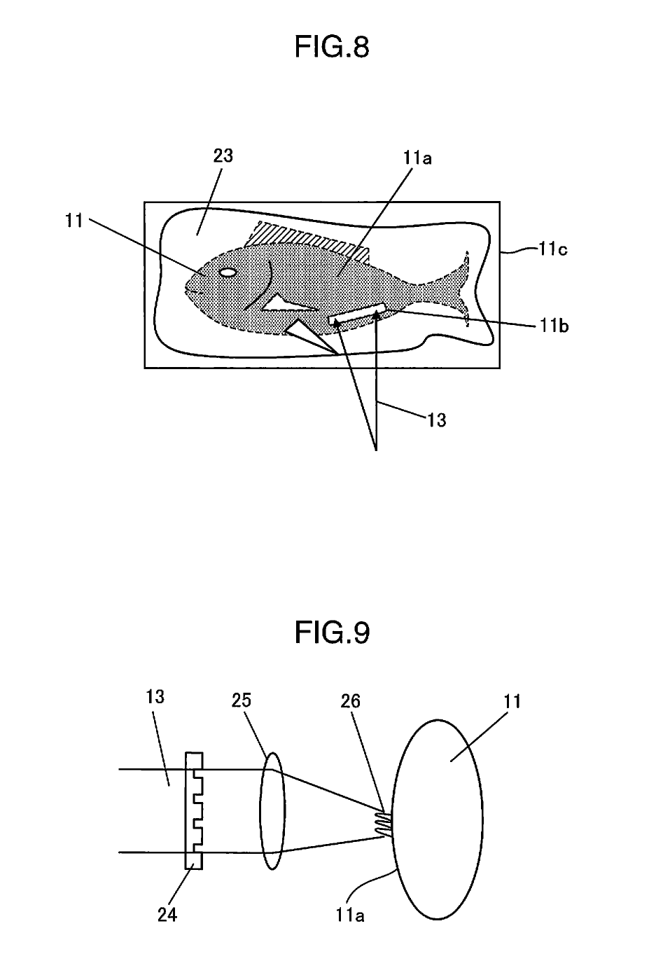

FIG. 8 is a plan view showing the relevant part of another printing apparatus according to the first embodiment of the present invention. As shown in FIG. 8, a water cooling sheet 23 (water cooling member) containing at least moisture or a coat containing moisture is additionally disposed on the surface 11a of the object to be printed 11, and the laser beam 13 is irradiated onto the object to be printed 11 via the water cooling sheet 23 or the coat. As a result of adopting this kind of configuration, it is possible to prevent the object to be printed from generating heat due to the laser beam 13. By using a visible laser beam 13 with a small absorption coefficient of water, even if the laser beam 13 is irradiated onto the object to be printed 11 via the cooling sheet 23 containing water or moisture, since the light will not be absorbed by the moisture or the cooling sheet 23, printing can be performed without any loss of the laser beam 13. Moreover, since there will not heating or damage of the cooling sheet 23, there is also an advantage in that the cooling sheet 23 can be repeatedly used.

FIG. 9 is a configuration diagram showing the relevant port of another printing apparatus according to the first embodiment. As shown in FIG. 9, the laser beam 13 is passed through a phase mask 24 and its interference pattern 26 is reduced with the objective lens 25 and used to mark the surface 11a of the object to be printed 11. According to this configuration, various types of information can be recorded on the surface 11a of the object to be printed 11 based on the interference pattern 26. Since printing is performed with the interference of light, a two-dimensional pattern can simultaneously be printed. Note that an optical element may be used in substitute for the phase mask 24 to branch the laser beam 13 in order to form the interference pattern 26 on the surface 11a of the object to be printed 11, and perform the marking by transferring such interference pattern 26 onto the surface 11a.

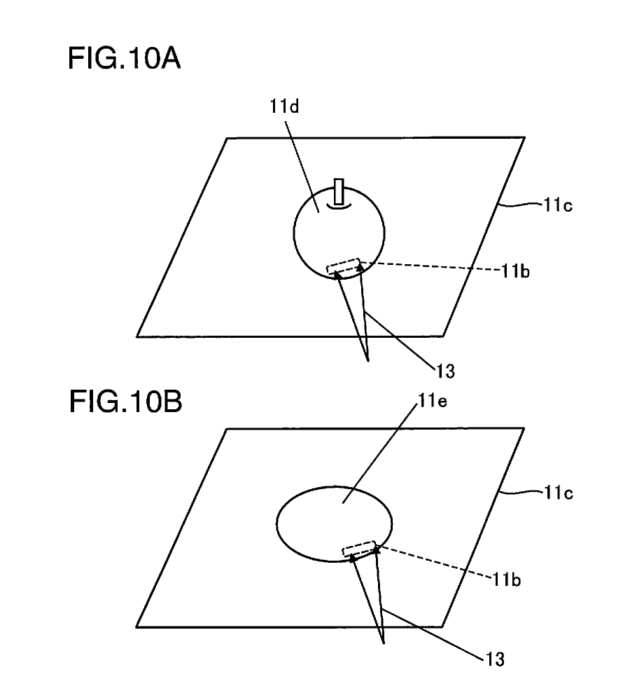

FIG. 10A shows a perspective view of a case where an apple as a fruit is placed on the mounting table 11c of the printing apparatus 10, 20 shown in FIG. 1 and FIG. 2 as the object to be printed 11d. Moreover, FIG. 10B shows a perspective view of a case where an egg is placed on the mounting table 11c of the printing apparatus 10, 20 shown in FIG. 1 and FIG. 2 as the object to be printed 11e.

Generally speaking, the moisture content of seafood is 20% to 80%, and certain shells and the like of shellfish are low at approximately 20%, but seafood generally contains approximately 80% of moisture. Moreover, fruits such as an apple also contain 80% or more of moisture, and even vegetable such as a green pepper also contain 70% or more of moisture. Moreover, even eggshells contain approximately 0.2% of moisture. The object to be printed 11 will suffice so as long as it contains moisture at least at the printing area 11b, and the effect of the present embodiment can be sufficiently yielded even with a moisture content of 0.1% or more (effect of being able to perform high resolution marking without damaging the object to be printed 11 containing moisture). This effect is further increased if the moisture content of the object to be printed 11 is 20% or more, and the effect becomes even more significant if the moisture content is 70% or more. Accordingly, as with the case where the object to be printed 11 is seafood, cases where the object to be printed 11 is perishable food demanded of freshness such as an egg, seafood, meat, vegetable, fruit or the like, the origin, date of packing and the like can be marked on the printing area 11b without impairing the freshness or quality.

### Second Embodiment

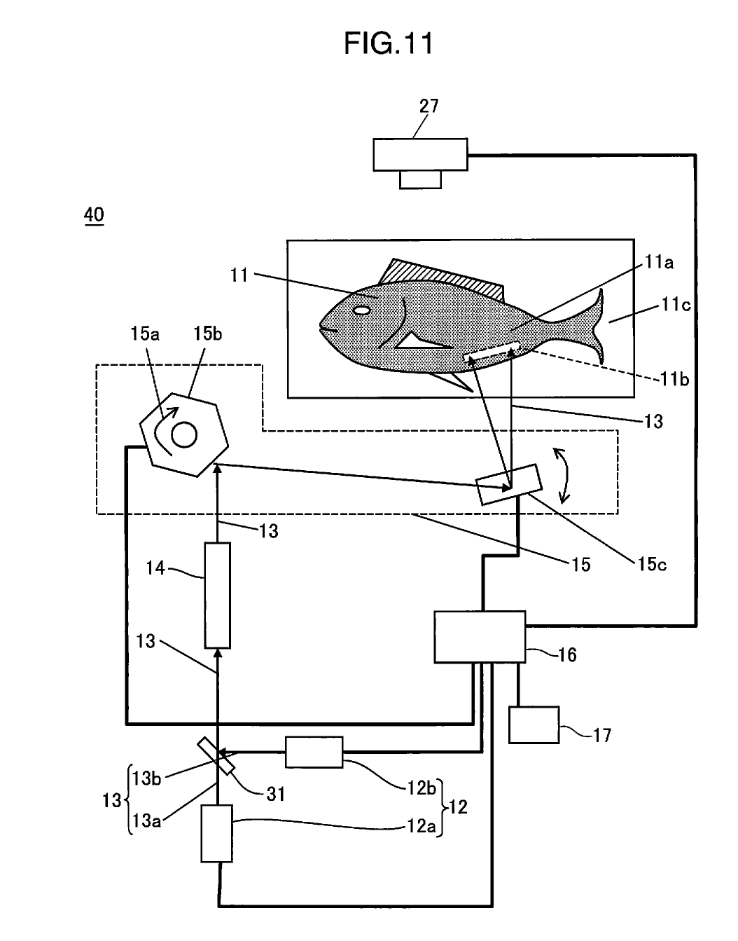

FIG. 11 shows a schematic configuration of the printing apparatus 40 according to the second embodiment of the present invention. The printing apparatus 40 is similar to the printing apparatus 10 of the first embodiment, but the laser beam source 12 includes a plurality of light sources 12a, 12b of different wavelengths, and the respective laser beams that are output from the light sources 12a, 12b are multiplexed with the dichroic mirror 31, and thereafter irradiated on the object to be printed 11 via a similar path as the printing apparatus 10. Here, the advantage of using one of the plurality of light sources 12a, 12b for an infrared laser is explained below.

The light source 12a outputs a visible laser beam 13a with a wavelength of 350 nm or more and 550 nm or less, and the light source 12b (second laser beam output unit) outputs an infrared laser beam 13b with a wavelength of 1 um or more and 20 um or less. To irradiate the infrared laser beam 13b simultaneously with or immediately before the visible laser beam 13a is effective for the surface cleaning of the object to be printed 11. If the surface of the object to be printed 11 is covered with moisture and the moisture is adhered as droplets, there is a problem in that the printing accuracy will deteriorate since the light collecting spot of the laser beam for printing will undergo deformation. Thus, if the infrared laser beam 13b can be used to evaporate the moisture on the surface of the portion to be printed in advance, this will result in the surface cleaning of the object to be printed 11, and the printing accuracy will thereby improve. Moreover, in the case of an object to be printed 11 containing moisture in the structure in the vicinity of the surface to be printed, there is a problem in that the printing quality will vary depending on the variation in the amount of moisture. In order to prevent this, a method of irradiating the infrared laser beam 13b with a high absorption coefficient of water on the surface of the object to be printed 11 to reduce the amount of moisture at such portion and unifying the surface condition may be adopted. Simultaneously, the printing speed can be increased by reducing the amount of moisture in the vicinity of the surface. As described above, as a result of using the infrared laser beam as a pretreatment of laser printing, the printing accuracy and printing speed can be improved, and the variation in the printing quality can be reduced.

If the infrared laser beam is to be used for the pretreatment of printing, desirably, the beam diameter of the infrared laser beam 13b on the object to be printed 11 is greater than the beam diameter of the visible laser beam 13a on the object to be printed 11. This is in order to clean the surface to be printed with certainty by securing the range of surface cleaning with the infrared laser beam to be broader than the printing range.

Moreover, as shown in FIG. 11, for example, by measuring the temperature of the printing area 11b of the object to be printed 11 with a two-dimensional temperature sensor 27 connected to the control unit 16, and adjusting the output of the infrared laser beam 13b through the control unit 16 so that the temperature of the location irradiated with the infrared laser beam 13b will become a prescribed temperature or higher, the moisture at the location to be irradiated with the visible laser beam 13a for printing can be eliminated with certainty. Consequently, it is possible to reliably prevent the deterioration in printing quality caused by droplets and moisture, and record information on the object to be printed 11 in high resolution. Although FIG. 11 showed an example of using the two-dimensional temperature sensor 27, the present invention is not limited thereto. For example, printing marks may be observed with a CCD camera or the like in substitute for the two-dimensional temperature sensor 27, and the output of the infrared laser beam 13b can be adjusted according to the thickness of the printing marks, or other methods may also be used.

In addition, if a wavelength conversion element having a periodic polarization inverted structure as explained in the first embodiment is used, and a second harmonic wave obtained by converting wavelength of the infrared laser beam is used as the visible laser beam, it is possible to adopt a configuration where the infrared light that was not wavelength-converted exists coaxially with the visible laser beam for printing can be realized. Generally speaking, if wavelength conversion is performed with a wavelength conversion element, the outgoing direction of the fundamental wave and the harmonic will differ. However, if the wavelength conversion element of the periodic polarization inverted structure is used, the outgoing direction of the fundamental wave and harmonic can be made coaxial. In the foregoing case, there is an advantage in that the infrared light that remained without being converted the wavelength with the wavelength conversion element can be used for the surface cleaning described above.

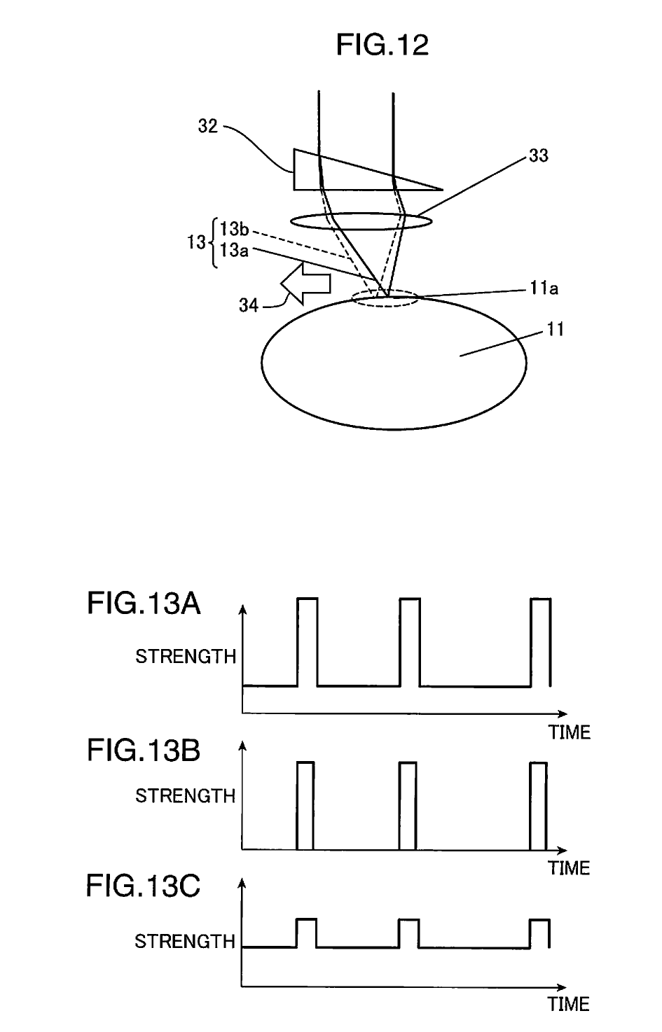

For example, if infrared light of 1064 nm is used as the fundamental wave, it is possible to perform printing with the visible laser beam 13a of 532 nm that was wavelength-converted with the wavelength conversion, and perform surface cleaning with the fundamental wave (infrared laser beam 13b) of 1064 nm that remained without being converted the wavelength. In the foregoing case, in order to irradiate the infrared laser beam 13b immediately before printing, as shown in FIG. 12, considered may be a configuration of providing a prism 32 and an objective lens 33 between the laser beam source (not shown) and the object to be printed 11. With this configuration, the laser beam 13 is branched into a visible laser beam 13a and an infrared laser beam 13b based on the refractive index difference of the respective laser beams of the prism 32, and the respective laser beams 13a, 13b are collected on the surface of the object to be printed 11 with the objective lens 33. By causing the laser beams 13a, 13b to perform scanning in the direction shown with the arrow 34, the moisture on the surface 11a of the area to be printed is evaporated with the infrared laser beam 13b, and printing can be subsequently performed to the object to be printed 11 with the visible laser beam 13a. Consequently, it is not necessary to prepare independent light sources for generating the visible laser beam 13a and the infrared laser beam 13b as shown in FIG. 11. Moreover, with a configuration using the wavelength conversion element, the infrared laser beam which was conventionally wasted can be used with economy, and power loss is also minimal. In addition, since it is not necessary to multiplex the visible laser beam 13a and the infrared laser beam 13b, there is no need to adjust the position of the visible laser beam 13a and the infrared laser beam 13b, and this is advantageous in terms of cost. If the infrared laser beam 13b and the visible laser beam 13a are to be irradiated simultaneously, the prism 32 and the objective lens 33 shown in FIG. 12 are not required.

Moreover, as described above, desirably, the beam diameter of the infrared laser beam 13b on the object to be printed 11 is greater than the beam diameter of the visible laser beam. If wavelength conversion is performed, the wavelength of the fundamental wave will be twice as long as the wavelength of the second harmonic wave, but the beam diameter of the fundamental wave in the far field is approximately v2 times the size of the beam diameter of the second harmonic wave. Thus, the beam diameter of the fundamental wave will be approximately v2 times greater even in the vicinity of the waist position. From this perspective also, it could be said that the wavelength conversion laser is a light source that is desirable in this configuration.

Here, the visible laser beam is preferably pulsed light as described above, but the infrared laser beam is desirably CW oscillation. This is because if the infrared laser beam is pulsed, the object to be printed could become damaged. Thus, in the case of the laser beam source 12 using the wavelength conversion element, it is desirable to leave the infrared laser beam 13b, which is a fundamental wave, as CW, and only generate pulses of the visible laser beam 13a as the obtained second harmonic wave. In the foregoing case, a wavelength conversion switch as described below can be used for only generating pulses of the second harmonic wave.

As an example of a modulation method for only generating pulses of the second harmonic wave, there is a method of applying a voltage to the wavelength conversion element and switching the phase matching state. Specifically, the phase matching conditions are set to be satisfied only when a voltage is applied to the wavelength conversion element, and a pulsed second harmonic wave can be achieved by periodically switching the application state and non-application state of the voltage. In the foregoing case, since the duty ratio of the output waveform of the second harmonic wave is several % or less, the fundamental wave is generated in a form that is similar to the CW light in terms of execution.

As another method of for only generating pulses of the second harmonic wave, the output of the second harmonic wave can be pulsed by modulating the oscillation wavelength of the fundamental wave. Since a fiber laser is able to switch the oscillation wavelength, the second harmonic wave can be switched by modulating the oscillation wavelength of the fundamental wave. Specifically, the oscillation wavelength can be switched by modulating, through expansion and contraction, the pitch of the grating of the fiber grating forming a resonator with the fiber laser by using an actuator or the like.

As yet another method of for only generating pulses of the second harmonic wave, the strength of the fundamental wave can be modulated. Specifically, as shown in FIG. 13A, the fundamental wave that enters the wavelength conversion element is biased and modulated. In a state where the fundamental wave is subject to pulse oscillation, the wavelength of the fundamental wave will shift slightly to the long wavelength side in comparison to a state where it is subject only to bias oscillation. Thus, if the phase matching temperature of the wavelength conversion element is controlled so that the phase will match the pulsed light generated state, as shown in FIG. 13B, the second harmonic wave will be generated only when the fundamental wave is subject to pulse oscillation. Meanwhile, since the fundamental wave that passed through the wavelength conversion element is wavelength-converted only during pulse oscillation, as shown in FIG. 13C, it will oscillate in a form that is similar to the CW. The fundamental wave that passed through the wavelength conversion element can be used for the pretreatment of the object to be printed.

### Third Embodiment

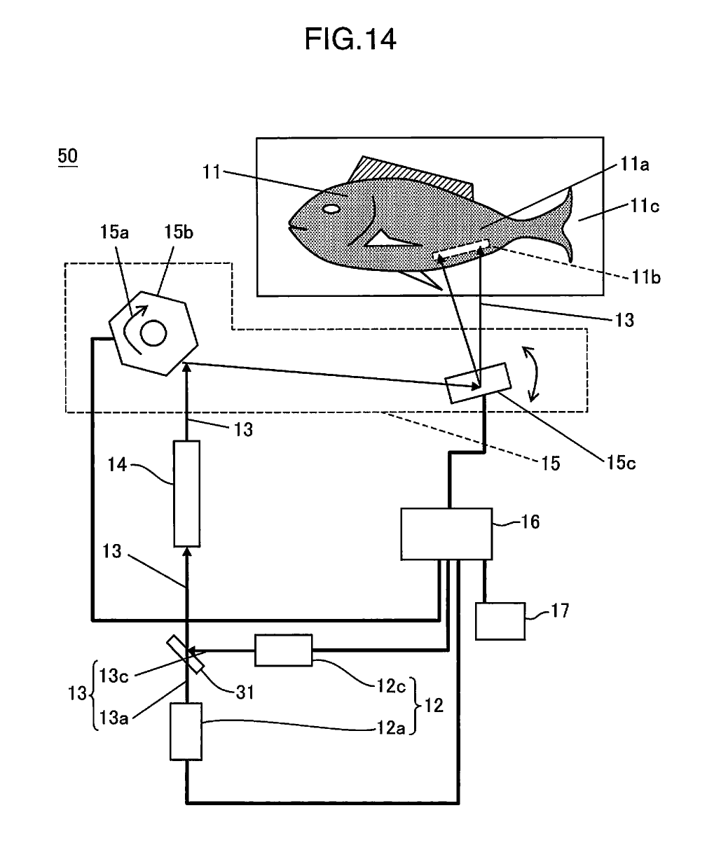

FIG. 14 shows the schematic configuration of the printing apparatus 50 according to the second embodiment of the present invention. As with the printing apparatus 40 of FIG. 11, the printing apparatus 50 includes a visible laser beam source 12a with a wavelength 350 nm or more and 550 nm or less for performing laser printing, but differs from the printing apparatus 40 of FIG. 11 in that it additionally includes an ultraviolet laser beam source 12c (third laser beam output unit) for outputting an ultraviolet laser beam 13c with a wavelength of 400 nm or less. Since the ultraviolet light with a wavelength of 400 nm or less yields a sterilization effect, it is effective in reducing the propagation of bacteria in animals and plants. Thus, by irradiating the ultraviolet light with a wavelength of 400 nm or less on the object to be printed 11 simultaneously with or immediately after the irradiation of the laser beam for performing printing, an effect is yielded in that it is possible to prevent the propagation of bacteria as the laser printing portion.

Desirably, the beam diameter of the ultraviolet laser beam 13c to be used for sterilization is greater than the beam diameter of the visible laser beam 13a to be used for printing on the object to be printed. This is because the effect of reducing germs at the printing portion can be reinforced by eliminating such germs up to the periphery of the printing portion.

Moreover, the power density of the ultraviolet laser beam 13c relative to the visible laser beam 13a for printing is preferably limited to 1% or less. If the ultraviolet laser beam becomes 1% or more of the laser beam strength for printing, the object to be printed 11 may begin to deteriorate as a result of the ultraviolet laser beam 13c. In the foregoing case, the appearance of the line at the discolored portion to be printed will look unattractive, but this kind of drawback can be overcome by inhibiting the power density of the ultraviolet laser beam 13c relative to the visible laser beam 13a for printing to be 1% or less as described above.

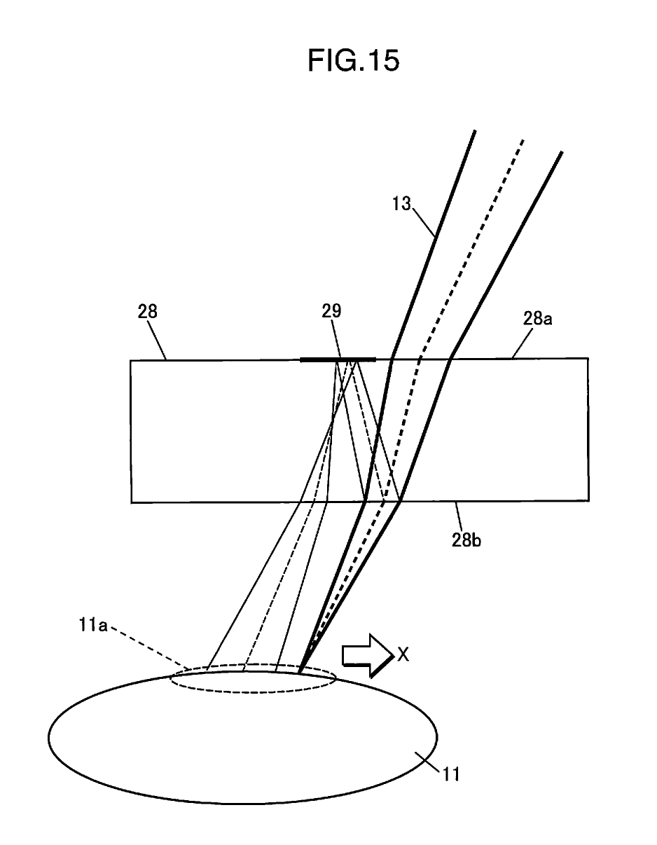

Moreover, a semiconductor laser beam source with a wavelength of 405 nm or 375 nm can also be used as the visible laser beam source 12a for printing. Since the sterilization effect will also be yielded if the wavelength is 375 nm, it can be commonly used with the ultraviolet laser beam source 12c for sterilization. In the foregoing case, for example, as shown in FIG. 15, a glass plate 28 may be used to branch a single light source for separating usage for printing and for sterilization. Most of the laser beam 13 that entered the entrance plane 28a of the glass plate 28 diagonally while being collected is output from the outgoing plane 28b of the glass plate 28, and enters the surface 11a of the object to be printed 11 and used for printing. Here, if an AR (Anti-Reflection) coat or the like is not applied to the outgoing plane 28b, approximately 3% will be reflected on the surface of the outgoing plane 28b, and propagate in the reverse direction in the glass plate 28 as shown in FIG. 15. If a coat 29 with a reflectance of 30% or less is applied at a position where the laser beam 13 that reflected off the surface at the outgoing plane 28b once again reaches the entrance plane 28a, 30% or less of the laser beam 13 that reached the entrance plane 28a will be reflected, and 1% or less of the laser beam to be used for printing will enter the vicinity of the printing light in a state of being spread. By performing scanning in the arrow X direction in FIG. 15 under the foregoing state, sterilization can be performed immediately after printing, and a single light source can be used to perform both printing and sterilization simply and without hardly any influence in terms of cost.

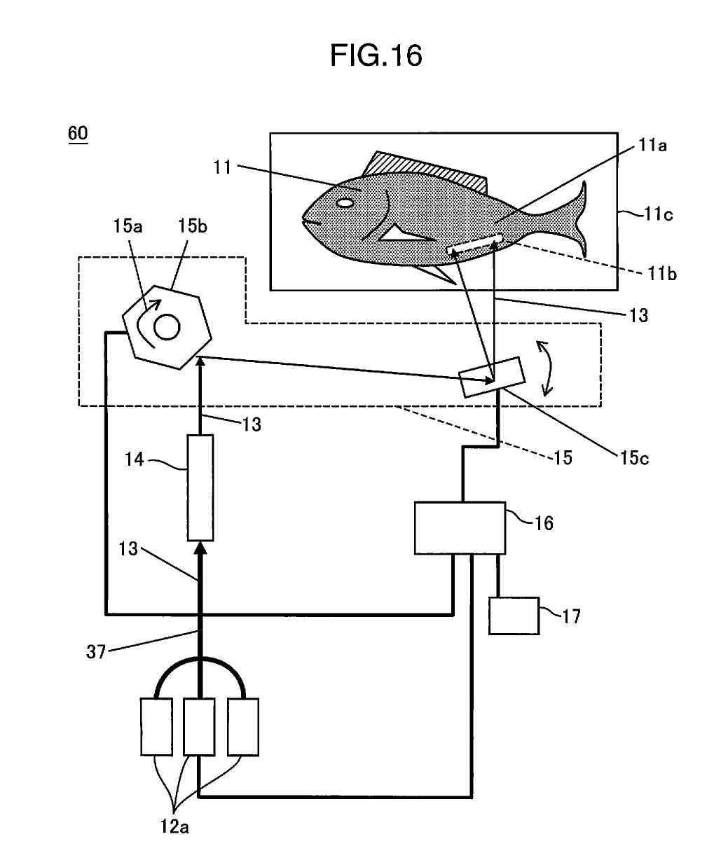

Moreover, if the power is insufficient with a single light source, a plurality of visible laser beam sources 12a may be bundled to a fiber 37 as with the printing apparatus 60 shown in FIG. 16 to achieve a high output, whereby high-speed printing is enabled.

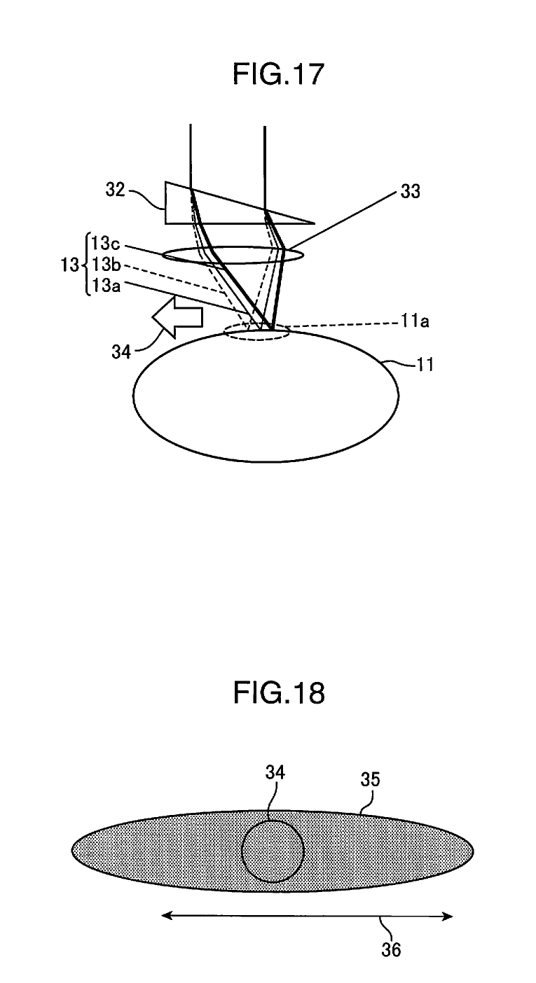

In addition, if the wavelength conversion element explained in the first embodiment is used to convert the fundamental wave of 1064 nm into a second harmonic wave of 532 nm, an ultraviolet laser beam of 355 nm is generated with the sum frequency of 1064 nm and 532 nm, or a third harmonic wave of 1064 nm. Here, as with the optical axis relation of the infrared laser beam 13b and the visible laser beam 13a of the second embodiment, the ultraviolet laser beam 13c of 355 nm and the visible laser beam 13a of 532 nm can be output coaxially. As a result of using the ultraviolet laser beam 13c of 355 nm generated here for sterilization and using the visible laser beam 13a of 532 nm for printing, the location printed with the visible laser beam 13a of 532 nm can be sterilized with the ultraviolet laser beam 13c of 355 nm without requiring a special optical system. Moreover, with this configuration, as explained in the second embodiment, since the fundamental wave (infrared laser beam 13b) of 1064 nm also exists, the surface cleaning of the printing area can also be performed. Here, in order to perform the surface cleaning with the infrared laser beam 13b of 1064 nm immediately before and to perform the sterilization with the ultraviolet laser beam 13c of 355 nm immediately after the printing performed with the visible laser beam 13a of 532 nm, as shown in FIG. 17, the laser beam should be caused to perform scanning in the direction shown with the arrow 34 in a state of passing through the prism 32 and the objective lens 33 as with FIG. 12.

As described above, preferably, the beam diameter of the ultraviolet laser beam 13c on the surface of the object to be printed 11 is greater than that of the visible laser beam 13a to be used for printing, but if a wavelength conversion laser is used as the light source and the visible laser beam 13a and the ultraviolet laser beam 13c positioned coaxially are simply collected with the lens, the ultraviolet laser beam 13c will be collected smaller since it has a shorter wavelength. Generally speaking, the waist diameter of a third harmonic wave or a sum frequency is v(⅔) in relation to the waist diameter of the second harmonic wave. In order to individually adjust the beam diameter of the visible laser beam 13a and the ultraviolet laser beam 13c positioned coaxially, it is effective to use a dual-wavelength lens provided with a relief hologram on the lens surface that is used as a pickup of optical disks (CD/DVD/BD and the like). By using the dual-wavelength lens as the objective lens 33 of FIG. 17, laser beams of different wavelengths can be respectively provided with different convergence characteristics, and the waist position can be located at different positions on the optical axis. Thus, it is possible to cause the ultraviolet laser beam 13c to have a larger beam diameter in comparison to the visible laser beam 13a on the surface of the object to be printed 11.

Moreover, as the wavelength conversion element, as with the first embodiment, it is preferable to use a nonlinear optical element configured from a periodic polarization inverted structure. As the crystal of the wavelength conversion element, MgO: LiNbO₃, Mg: LiTaO₃, and KTP can be used, and as such crystal structure there is a congruent composition, stoichiometric composition, quartz crystal, fluoride crystal, and the like. There are two advantages in using a nonlinear optical crystal having a periodic polarization inverted structure. The first advantage is that the strength of the visible laser beam and the ultraviolet laser beam can be designed based on the periodic structure of the polarization inversion. As described above, it is desirable to inhibit the strength of the ultraviolet laser beam in relation to the visible laser beam. Moreover, depending on the material to be printed, it is necessary to control the strength ratio of the visible laser beam and the ultraviolet laser beam. In the foregoing case, the strength of the visible laser beam and the ultraviolet laser beam can be designed by designing the period of the periodic polarization inverted structure. For example, by forming a periodic polarization inverted structure that generates a visible laser beam at the first half part of the crystal and forming a periodic polarization inverted structure that generates an ultraviolet laser beam at the second half part of the crystal, the visible laser beam and the ultraviolet laser beam can be generated simultaneously. The other advantage is that non-critical phase matching, in which the optical axis of laser beams of a plurality of wavelengths can be made the same, is possible. As explained in the second embodiment, generally speaking, if wavelength conversion is performed with a wavelength conversion element, the outgoing direction of the infrared laser beam, the visible laser beam, and the ultraviolet laser beam will differ. It is difficult to make the outgoing directions coaxial since it is necessary to control the double refractive index of the crystal. Meanwhile, if the wavelength conversion element of the periodic polarization inverted structure is used, the infrared laser beam, the visible laser beam, and the ultraviolet laser beam can be generated coaxially. Thus, the printing apparatus of the present embodiment is effective as the configuration of collecting the visible laser beam and the ultraviolet laser beam coaxially to perform printing.

Note that the wavelength of the ultraviolet laser beam is preferably 400 nm or less for a great sterilization effect, but a wavelength in a range of 300 nm to 400 nm is even more preferable. As shown in FIG. 4, since the wavelength of this range has high water transmittance, the ultraviolet laser beam easily permeates to the inside of the object to be printed containing moisture, and the range of the sterilization effect can be expanded. The effect of preventing the deterioration in the freshness of the perishable food is thereby further increased.

Note that a laser beam source was used in the present embodiment for generating ultraviolet light, but an LED may also be used. The sterilization effect is also yielded by performing printing while irradiating the marking portion with an LED lamp.

In the present embodiment, the sterilization effect was yielded while performing printing by irradiating the respective laser beams so that the light collecting spot of the ultraviolet laser beam will be greater than the light collecting spot of the visible laser beam used for printing. Nevertheless, as shown in FIG. 18, high speed printing can be realizing by causing the ultraviolet laser beam shape 35 to be an oval shape with a greater beam cross section in relation to the visible laser beam shape 34. If the scanning speed of the beam becomes faster, the time that the ultraviolet laser beam is irradiated will become shorter, and the sterilization effect will weaken. However, if the strength of the ultraviolet laser beam is increased in order to increase the sterilization effect, there is a problem in that the object to be printed could be subject to deterioration, discoloration or the like. Thus, as shown in FIG. 18, by causing the ultraviolet laser beam shape 35 to be an oval shape with a long axis in the beam scanning direction 36, the irradiation time can be prolonged while inhibiting the strength of the ultraviolet laser beam, and high speed printing is thereby enabled.

The printing apparatus according to one aspect of the present invention is a printing apparatus for printing information on a printing area of an object to be printed by irradiating the object to be printed with a first laser beam, including a light source for outputting the first laser beam, a light collecting optical system for collecting the first laser beam to the printing area of the object to be printed, and a scanning unit for performing scanning with the first laser beam, wherein the object to be printed contains moisture at least in the printing area, and wherein a wavelength of the first laser beam is 350 nm or more and 550 nm or less.

According to the foregoing configuration, a first laser beam of a wavelength band of 350 nm or more and 550 nm or less is irradiated onto an object to be printed containing moisture in the printing area in order to print information on the object to be printed. Here, with the wavelength band of 350 nm or more and 550 nm or less, the absorption coefficient of water is 0.001 cm⁻¹ or less, and this is a value that is 2 digits to 6 digits lower in comparison to the wavelength band that is conventionally used for printing. Thus, it is possible to considerably inhibit the absorption of the laser beam by the moisture of the object to be printed. Consequently, the moisture contained in the object to be printed will not be heated excessively and vapor explosion or the like will not occur. Accordingly, high resolution printing can be performed without damaging the object to be printed. In addition, since absorption by the moisture is small, printing can be performed with smaller power than conventionally, and it is thereby possible to reduce the power required for printing.

In the foregoing configuration, preferably, the light source includes a fiber laser for outputting a fundamental wave in which its transverse mode is a single mode, and a wavelength conversion element for converting wavelength of the fundamental wave into a second harmonic wave, and the first laser beam is the second harmonic wave.

According to the foregoing configuration, the light source includes a fiber laser capable of generating a high output fundamental wave, and a wavelength conversion element, and a fundamental wave in which its transverse mode is a single mode is wavelength-converted into a second harmonic wave. The beam quality of the first laser beam can thereby be improved dramatically. Specifically, the second harmonic wave that is obtained by converting wavelength of the fundamental wave becomes a high quality beam in which the transverse mode is a single mode. Since the first laser beam that is used for printing is this kind of high quality second harmonic wave, the spread angle is small and even higher resolution printing is possible. Moreover, since a high quality first laser beam with a small spread angle is used for printing, focus adjustment is no longer required, and the printing apparatus can be configured at a low cost.

In the foregoing configuration, preferably, the light source further includes a second laser beam output unit for outputting a second laser beam with a wavelength of 1 μm or more and 20 μm or less, and the second laser beam is irradiated onto a portion to be irradiated with the first laser beam of the object to be printed simultaneously with the irradiation of the first laser beam or immediately before the irradiation of the first laser beam.

According to the foregoing configuration, the surface cleaning of eliminating droplets and the like adhered to the printing area of the object to be printed can be performed simultaneously with or immediately before the irradiation of the first laser beam. Specifically, the second laser beam with a wavelength of 1 um or more and 20 um or less has a high absorption coefficient of water, and vaporizes the moisture such as the droplets adhered to the printing area of the object to be printed. If droplets and the like are adhered to the printing area of the object to be printed, the light collecting characteristics of the laser beam may deteriorate due to the droplets, or there may be variation in the printing quality cased by the variation in the amount of moisture. Thus, as a result of unifying the surface condition of the object to be printed by performing surface cleaning with the second laser beam, it is possible to improve the printing accuracy and printing speed, as well as reduce the variation in the printing quality.

In the foregoing configuration, preferably, the light source further includes a wavelength conversion element for converting wavelength of the second laser beam into a second harmonic wave, and the first laser beam is a second harmonic wave obtained by converting wavelength of the second laser beam.

According to the foregoing configuration, since the first laser beam is generated by converting wavelength of the second laser beam with the wavelength conversion element, there is no need to prepare separate laser beam sources for generating the first laser beam and the second laser beam. Moreover, since the first laser beam and the second laser beam can be output coaxially, there is no need for a member to multiplex the laser beams. Thus, the printing apparatus can be configured at a low cost. Moreover, since the second laser beam that remained without being converted the wavelength into the first laser beam can be used for the surface cleaning with economy, it is possible to realize a printing apparatus with low power loss and high energy efficiency.

In the foregoing configuration, preferably, the light source modulates the second laser beam to a pulsed light with a bias that oscillates at a different wavelength during bias and during pulse oscillation and causes the pulsed light to enter the wavelength conversion element, and the wavelength conversion element has a phase matching temperature for performing phase matching at a wavelength during pulse oscillation of the second laser beam.

According to the foregoing configuration, it is possible to generate the first laser beam as a second harmonic wave only during the pulse oscillation of the second laser beam. Meanwhile, the second laser beam that was not wavelength-converted and which was transmitted through the wavelength conversion element will become substantially a CW (Continuous Wave). As described above, since it is possible to subject only the first laser beam to pulse oscillation, high resolution printing is enabled by inhibiting the generation of heat in the object to be printed, and the object to be printed will not be damaged with the second laser beam as the substantially CW.

In the foregoing configuration, preferably, the light source further includes a third laser beam output unit for outputting a third laser beam with a wavelength of 400 nm or less, and a beam diameter of the third laser beam in the printing area of the object to be printed is greater than a beam diameter of the first laser beam.

The third laser beam with a wavelength of 400 nm or less yields a sterilization effect. Thus, according to the foregoing configuration, by causing the beam diameter of the third laser beam to be greater than the beam diameter of the first laser beam in the printing area of the object to be printed, the printing area of the object to be printed can be sterilized with certainty, and the propagation of bacteria can be prevented.

In the foregoing configuration, preferably, power density of the third laser beam is lower than power density of the first laser beam.

According to the foregoing configuration, the printing area can be sterilized without damaging the object to be printed.

In the foregoing configuration, preferably, the light source includes a third laser beam output unit for outputting a third laser beam with a wavelength of 400 nm or less, a beam diameter of the third laser beam in the printing area of the printing object is greater than a beam diameter of the first laser beam, and the third laser beam is a third harmonic wave obtained by converting wavelength of the second laser beam, or a sum frequency of the first laser beam and the second laser beam.

According to the foregoing configuration, since the third laser beam and the first and second laser beams can be output coaxially, there is no need for a member to multiplex the respective laser beams. Thus, the printing apparatus can be configured at a low cost. Moreover, since the first laser beam and the second laser beam are used to generate the third laser beam, it is possible to realize a printing apparatus with low power loss and high energy efficiency.

In the foregoing configuration, preferably, the printing apparatus further comprises a water cooling member containing at least moisture and disposed in the printing area of the object to be printed, and the object to be printed is irradiated with the first laser beam via the water cooling member.

According to the foregoing configuration, since a first laser beam of a wavelength band with a small absorption coefficient of water is used for printing, the first laser beam will not be absorbed by the water cooling member even if the first laser beam is irradiated onto the object to be printed via the water cooling member containing moisture. Thus, since printing can be performed while cooling the object to be printed with the water cooling member, it is possible to inhibit the generation of heat in the printing area, and consequently prevent the object to be printed from becoming damaged.

In the foregoing configuration, the printing apparatus further comprises a phase mask, and an interference pattern is formed in the printing area of the object to be printed by irradiating the object to be printed with the first laser beam via the phase mask.

According to the foregoing configuration, a two-dimensional pattern can be easily recorded.

In the foregoing configuration, the printing apparatus further comprises a GPS sensor, and information printed on the object to be printed includes current position information detected by the GPS sensor.

According to the foregoing configuration, this will lead to the prevention of fish poaching or mislabeling, improve the brand value of the object to be printed which was printed with the printing apparatus, and bring a sense of safety to the buyers.

In the foregoing configuration, the printing apparatus further comprises a water tank to be used for placing the object to be printed in water, and the first laser beam is irradiated onto the object to be printed in the water tank.

According to the foregoing configuration, since the absorption of the first laser beam by water is extremely small, printing can be performed to the object to be printed in the water placed in the water tank. Here, the light collecting characteristics of the laser beam will not deteriorate due to the droplets as in the case of recording information upon removing the object to be printed from the water tank, and high resolution printing is enabled.

In the foregoing configuration, the printing apparatus further comprises a water flow generation unit for generating a water flow in a prescribed direction in the water tank, and the first laser beam is used to perform printing on the object to be printed which flows along the water flow.

According to the foregoing configuration, the object to be printed can be continuously printed while causing it to flow along the water flow, and the printing throughput can be dramatically improved thereby.

In the foregoing configuration, preferably, a width and a height of a cross section that is orthogonal to the direction of the water flow of the water tank are respectively shorter than a length in the direction of the water flow of the object to be printed which flows along the water flow.

According to the foregoing configuration, since it is possible to prevent the object to be printed from flowing in the water tank in a reverse direction against the water flow, the printing throughput can be improved.

In the foregoing configuration, preferably, a width of a cross section that is orthogonal to the direction of the water flow of the water tank is smaller than twice a width of a cross section that is orthogonal to the direction of the water flow of the object to be printed which flows along the water flow, and a height of the cross section that is orthogonal to the direction of the water flow of the water tank is smaller than twice a height of the cross section that is orthogonal to the direction of the water flow of the object to be printed which flows along the water flow.

According to the foregoing configuration, since it is possible to prevent two objects to be printed from simultaneously flowing in the water tank, printing omissions can be eliminated.

In the foregoing configuration, preferably, the first laser beam is single polarization, and enters at a Brewster's angle relative to a normal line of a surface of the water tank.

According to the foregoing configuration, the reflection of the first laser beam on the surface of the water tank can be inhibited, and it is thereby possible to realize a safe, lossless and highly efficient printing apparatus.

In the foregoing configuration, preferably, the object to be printed is perishable food demanded of freshness such as an egg, seafood, meat, vegetable, fruit and the like.

If perishable food such as an egg, seafood, meat, vegetable or fruit as described above is used as the object to be printed, this is effective since the commodity value will not deteriorate and hardly any damage will be suffered by the perishable food even after the printing.

The printing method according to another aspect of the present invention is a printing method using the printing apparatus according to any one of the foregoing configurations, comprising a step of disposing a coat or a water cooling sheet containing at least moisture in a printing area of the object to be printed, and a step of irradiating the object to be printed with the first laser beam via the coat or water cooling sheet.

According to the foregoing configuration, since printing can be performed to the object to be printed while cooling it with the water cooling member, it is possible to inhibit the generation of heat in the printing area and consequently prevent the object to be printed from becoming damaged.

The printing method according to yet another aspect of the present invention is a printing method using the printing apparatus according to any one of the foregoing configurations, comprising a step of disposing a phase mask in an optical path of the first laser beam, and a step of forming an interference pattern in the printing area of the object to be printed by irradiating the object to be printed with the first laser beam via the phase mask.

According to the foregoing configuration, a two-dimensional pattern can be easily recorded.

### INDUSTRIAL APPLICABILITY

The present invention provides a printing apparatus capable of performing high resolution marking only on the surface of the object to be printed by inhibiting the rise in temperature of the printing area of the object to be printed as a result of inhibiting the laser beam from being absorbed by the moisture contained in the object to be printed, and effective marking can be performed to general foodstuffs easily and at low cost. Accordingly, the present invention can be utilized in quality management of foods such as indicating the origin, date of packing and freshness date of foods.

Note that the specific embodiments and examples explained in the detailed description of the invention are merely for clarifying the technical subject matter of the present invention. Thus, this invention should not be narrowly interpreted by being limited to such specific examples, and the present invention may be variously modified and implemented within the spirit of this invention and the scope of claims indicated below.

1-20. (canceled)

21. A printing apparatus for printing information on a printing area of an object to be printed by irradiating the object to be printed with a first laser beam, comprising:
a light source for outputting the first laser beam;
a light collecting optical system for collecting the first laser beam to the printing area of the object to be printed; and
a scanning unit for performing scanning with the first laser beam,
wherein the object to be printed contains moisture at least in the printing area, and
a wavelength of the first laser beam is 350 nm or more and 550 nm or less.

22. The printing apparatus according to claim 21,
wherein the light source includes a fiber laser for outputting a fundamental wave in which its transverse mode is a single mode, and a wavelength conversion element for converting wavelength of the fundamental wave into a second harmonic wave, and
the first laser beam is the second harmonic wave.

23. The printing apparatus according to claim 21,
wherein the light source further includes a second laser beam output unit for outputting a second laser beam with a wavelength of 1 μm or more and 20 μm or less, and
the second laser beam is irradiated onto a portion to be irradiated with the first laser beam of the object to be printed simultaneously with the irradiation of the first laser beam or immediately before the irradiation of the first laser beam, and a beam diameter of the second laser beam is greater than that of the first laser beam in the object to be printed.

24. The printing apparatus according to claim 23,
wherein the light source further includes a wavelength conversion element for converting wavelength of the second laser beam into a second harmonic wave, and
the first laser beam is the second harmonic wave obtained by converting wavelength of the second laser beam.

25. The printing apparatus according to claim 24,
wherein the light source modulates the second laser beam to a pulsed light with a bias that oscillates at a different wavelength during bias and during pulse oscillation and causes the pulsed light to enter the wavelength conversion element, and
the wavelength conversion element has a phase matching temperature for performing phase matching at a wavelength during pulse oscillation of the second laser beam.

26. The printing apparatus according to claim 21,
wherein the light source further includes a third laser beam output unit for outputting a third laser beam with a wavelength of 400 nm or less, and
a beam diameter of the third laser beam in the printing area of the object to be printed is greater than a beam diameter of the first laser beam.

27. The printing apparatus according to claim 26,
wherein power density of the third laser beam is lower than power density of the first laser beam.

28. The printing apparatus according to claim 23,
wherein the light source includes a third laser beam output unit for outputting a third laser beam with a wavelength of 400 nm or less,
a beam diameter of the third laser beam in the printing area of the object to be printed is greater than a beam diameter of the first laser beam, and
the third laser beam is a third harmonic wave obtained by converting wavelength of the second laser beam, or a sum frequency of the first laser beam and the second laser beam.

29. The printing apparatus according to claim 21,
further comprising a water cooling member containing at least moisture and disposed in the printing area of the object to be printed,
wherein the object to be printed is irradiated with the first laser beam via the water cooling member.

30. The printing apparatus according to claim 21,
further comprising a phase mask,
wherein an interference pattern is formed in the printing area of the object to be printed by irradiating the object to be printed with the first laser beam via the phase mask.

31. The printing apparatus according to claim 21,
further comprising a GPS sensor,
wherein information printed on the object to be printed includes current position information detected by the GPS sensor.

32. The printing apparatus according to claim 21,
further comprising a water tank to be used for placing the object to be printed in water,
wherein the first laser beam is irradiated onto the object to be printed in the water tank.

33. The printing apparatus according to claim 32,
further comprising a water flow generation unit for generating a water flow in a prescribed direction in the water tank,
wherein the first laser beam is used to perform printing on the object to be printed which flows along the water flow.

34. The printing apparatus according to claim 33,
wherein a width and a height of a cross section that is orthogonal to the direction of the water flow of the water tank are respectively shorter than a length in the direction of the water flow of the object to be printed which flows along the water flow.

35. The printing apparatus according to claim 33,
wherein a width of a cross section that is orthogonal to the direction of the water flow of the water tank is smaller than twice a width of a cross section that is orthogonal to the direction of the water flow of the object to be printed which flows along the water flow, and
a height of the cross section that is orthogonal to the direction of the water flow of the water tank is smaller than twice a height of the cross section that is orthogonal to the direction of the water flow of the object to be printed which flows along the water flow.

36. The printing apparatus according to claim 32,
wherein the first laser beam is single polarization, and enters at a Brewster's angle relative to a normal line of a surface of the water tank.

37. The printing apparatus according to claim 21,
wherein the object to be printed is an egg.

38. The printing apparatus according to claim 21,
wherein the object to be printed is seafood.

39. The printing apparatus according to claim 21,
wherein the object to be printed is perishable food of a vegetable or a fruit.

40. A printing method using the printing apparatus according to claim 21, comprising:
a step of disposing a coat or a water cooling sheet containing at least moisture in a printing area of the object to be printed; and
a step of irradiating the object to be printed with the first laser beam via the coat or water cooling sheet.
